(19) United States
(12) Patent Application Publication
(10) Pub. No.: US 2006/0222774 A1
(43) Pub. Date: Oct. 5, 2006

(54) Flame retardant foam for EMI shielding gaskets

(76) Inventor: William I. Flanders, Merimack, NH (US)

Correspondence Address: John A. Molnar, Jr.;PARKER-HANNIFIN CORPORATION, 6035 Parkland Boulevard, Cleveland, OH, 44124-4141, US

(21) Appl. No.: 11/387,412

(22) Filed: Mar. 23, 2006

Related U.S. Application Data
(60) Provisional application No. 60/666,401, filed on Mar. 30, 2005.

(51) Int. Cl. B05D 1/18; B05D 3/12

(52) U.S. Cl. 427/393.3; 427/430.1; 427/355

(57) ABSTRACT

A flame retardant, electromagnetic interference (EMI) shielding gasket construction. The construction includes a resilient core member formed of a layer of a foamed polymeric material which is rendered flame retardant by being immersed a solution of a flame retardant composition and alternately compressed and relaxed while so immersed to effect the uptake the solution into the material.

CROSS-REFERENCE TO RELATED CASES

The present application claims the benefit of the filing date of U.S. Provisional Application Ser. No. 60/666,401, filed Mar. 30, 2005, the disclosure of which is expressly incorporated herein by reference.

BACKGROUND OF THE INVENTION

The present invention relates broadly to gaskets for providing electromagnetic interference (EMI) shielding and weather, dust, or other environmental sealing, and particularly to a multi-planar gasket construction having foam core which is especially adapted for use with I/O panels, backplanes, connectors, access panels, and the like.

The operation of electronic devices such as televisions, radios, computers, medical instruments, business machines, communications equipment, and the like is attended by the generation of electromagnetic radiation within the electronic circuitry of the equipment. As is detailed in U.S. Pat. Nos. 5,202,536; 5,142,101; 5,105,056; 5,028,739; 4,952,448; and 4,857,668, such radiation often develops as a field or as transients within the radio frequency band of the electromagnetic spectrum, i.e., between about 10 KHz and 10 GHz, and is termed “electromagnetic interference” or “EMI” as being known to interfere with the operation of other proximate electronic devices.

To attenuate EMI effects, shielding having the capability of absorbing and/or reflecting EMI energy may be employed both to confine the EMI energy within a source device, and to insulate that device or other “target” devices from other source devices. Such shielding is provided as a barrier which is inserted between the source and the other devices, and typically is configured as an electrically conductive and grounded housing which encloses the device. As the circuitry of the device generally must remain accessible for servicing or the like, most housings are provided with openable or removable accesses such as doors, hatches, panels, or covers. Between even the flattest of these accesses and its corresponding mating or faying surface, however, there may be present gaps which reduce the efficiency of the shielding by presenting openings through which radiant energy may leak or otherwise pass into or out of the device. Moreover, such gaps represent discontinuities in the surface and ground conductivity of the housing or other shielding, and may even generate a secondary source of EMI radiation by functioning as a form of slot antenna. In this regard, bulk or surface currents induced within the housing develop voltage gradients across any interface gaps in the shielding, which gaps thereby function as antennas which radiate EMI noise. In general, the amplitude of the noise is proportional to the gap length, with the width of the gap having less appreciable effect.

For filling gaps within mating surfaces of housings and other EMI shielding structures, gaskets and other seals have been proposed both for maintaining electrical continuity across the structure, and for excluding from the interior of the device such contaminates as moisture and dust. Such seals are bonded or mechanically attached to, or press-fit into, one of the mating surfaces, and function to close any interface gaps to establish a continuous conductive path thereacross by conforming under an applied pressure to irregularities between the surfaces. Accordingly, seals intended for EMI shielding applications are specified to be of a construction which not only provides electrical surface conductivity even while under compression, but which also has a resiliency allowing the seals to conform to the size of the gap. The seals additionally must be wear resistant, economical to manufacture, and capability of withstanding repeated compression and relaxation cycles. EMI shielding gaskets and other electrically-conductive materials, their methods of manufacture, and their use are further described in U.S. Pat. Nos. 6,121,545; 6,096,413; 6,075,205; 5,996,220; 5,910,524; 5,902,956; 5,902,438; 5,882,729; 5,804,762; 5,731,541; 5,641,438; 5,603,514; 5,584,983; 5,578,790; 5,566,055; 5,524,908; 5,522,602; 5,512,709; 5,438,423; 5,294,270; 5,202,536; 5,142,101; 5,141,770; 5,136,359; 5,115,104; 5,107,070; 5,105,056; 5,068,493; 5,054,635; 5,049,085; 5,028,739; 5,008,485; 4,988,550; 4,979,280; 4,968,854; 4,952,448; 4,931,479; 4,931,326; 4,871,477; 4,864,076; 4,857,668; 4,800,126; 4,529,257; 4,441,726; 4,301,040; 4,231,901; 4,065,138; 3,758,123; 3,026,367; 2,974,183; and 2,755,079, in U.S. Pat. Appln. Publ. No. 20020010223, International (PCT) Pat. Appln. Nos. WO 01/71223; 01/54467; 00/23,513; 99/44,406; 98/54942; 96/22672; and 93/23226, Japanese Patent Publication (Kokai) No. 7177/1993, European Pat. Appln. No. 1,094,257, German Pat. No. 19728839, and Canadian Patent No. 903,020, in Severinsen, J., “Gaskets That Block EMI,” Machine Design, Vol. 47, No. 19, pp. 74-77 (Aug. 7, 1975), and in the following publications of the Chomerics Division of Parker Hannifin Corporation, Woburn, Mass.: “SOFT-SHIELD® 1000 Series;” “SOFT-SHIELD® 2000 Series;” “SOFT-SHIELD® 4000 Series;” “SOFT-SHIELD 5000 Series;” and “SOFT-SHIELD® 5500, Preliminary Product Data Sheet (1998) Series; “COMBO® STRIP Gaskets;” “SPRINGMESH™ Highly Resilient EMI Mesh Gasket,” Technical Bulletin 114; “METAL STRIP® All Metal Gaskets;” “SHIELDMESH™ Compressed Mesh Gaskets;” and “METALKLIP® Clip-On EMI Gasket.”

EMI shielding gaskets typically are constructed as a resilient element, or a combination of one or more resilient elements having gap-filling capabilities. One or more of the elements may be provided as a tubular or solid, foamed or unfoamed core or strip which is filled, sheathed, or coated to be electrically-conductive, or otherwise which is formed of an inherently conductive material such as a metal wire spring mesh. One or more of the other elements, and particularly in the case of a composite or “combination gasket” having a conductive EMI shielding element in combination with an integral weather sealing strip (such as is sold commercially by the Chomerics Division of Parker-Hannifin Corporation (Woburn, Mass.) under the name “COMBO® STRIP Gasket”), may be formed of a sheet, strip, “picture-frame,” or other open or closed geometry of a solid, i.e., unfoamed, or foamed elastomeric material providing enhanced environmental sealing capabilities to which the conductive element is adhesively-bonded or otherwise joined. Each of the core or strip of the conductive element and the elastomeric material of the environmental sealing element may be formed of an elastomeric thermoplastic material such as polyethylene, polypropylene, or polyvinyl chloride, a thermoplastic or thermosetting rubber such as a butadiene, styrene-butadiene, nitrile, chlorosulfonate, neoprene, urethane, or silicone, or a blend such as polypropylene-EPDM. Conductive materials for the filler, sheathing, or coating of the conductive element include metal or metal-plated particles, fabrics, meshes, and fibers. Preferred metals include copper, nickel, silver, aluminum, tin or an alloy such as Monel, with preferred fibers and fabrics including natural or synthetic fibers such as cotton, wool, silk, cellulose, polyester, polyamide, nylon, polyimide. Alternatively, other conductive particles and fibers such as carbon, graphite, or a conductive polymer material may be substituted.

Conventional manufacturing processes for EMI shielding gaskets include extrusion, molding, die-cutting, and form-in-place (FIP). In this regard, die-cutting involves the forming of the gasket from a cured sheet of an electrically-conductive elastomer which is cut or stamped using a die or the like into the desired configuration. Molding, in turn, involves the compression or injection molding of an uncured or thermoplastic elastomer into the desired configuration. FIP, as described in commonly-assigned U.S. Pat. Nos. 6,096,413; 5,910,524; 5,641,438; 4,931,479, and International (PCT) Pat. Appln. No. 96/22672; and in U.S. Pat. Nos. 5,882,729 and 5,731,541, International (PCT) Pat. Appln. No. WO 01/71223, and Japanese Patent Publication (Kokai) No. 7177/1993, involves the application of a bead of a viscous, curable, electrically-conductive composition which is dispensed in a fluent state from a nozzle directly onto to a surface of a substrate such as a housing or other enclosure. The composition, typically a silver-filled or otherwise electrically-conductive silicone or polyurethane foamed or unfoamed elastomer, then is foamed and/or cured-in-place via a chemical, thermal, or physical reaction which may be initiated or catalyzed via the application of heat or with atmospheric moisture or ultraviolet (UV) radiation to form an electrically-conductive, elastomeric EMI shielding gasket profile in situ on the substrate surface.

Requirements for typical EMI shielding applications often dictate a low impedance, low profile gasket which is deflectable under normal closure force loads. Other requirements include low cost and a design which provides an EMI shielding effectiveness for both the proper operation of the device and compliance, in the United States, with commercial Federal Communication Commission (FCC) EMC regulations.

Particularly economical gasket constructions, which also requires very low closure forces, i.e. less than about 1 lb/inch (0.175 N/mm), is marketed by the Chomerics Division of Parker-Hannifin Corp., Woburn, Mass. under the tradenames “Soft-Shield 5000 Series” and “Soft-Shield® 3500 Series.” Such constructions consist of an electrically-conductive jacket or sheathing which is “cigarette” wrapped lengthwise over a polyurethane or other foam core. As is described further in U.S. Pat. No. 4,871,477, polyurethane foams generally are produced by the reaction of polyisocyanate and a hydroxyl-functional polyol in the presence of a blowing agent. The blowing agent effects the expansion of the polymer structure into a multiplicity of open or closed cells.

The jacket is provided as a highly conductive, i.e., about 1 Ω-sq., nickel-plated-silver, woven rip-stop nylon which is self-terminating when cut. Advantageously, the jacket may be bonded to the core in a continuous molding process wherein the foam is blown or expanded within the jacket as the jacket is wrapped around the expanding foam and the foam and jacket are passed through a die and into a traveling molding. Similar gasket constructions are shown in commonly-assigned U.S. Pat. No. 5,028,739 and in U.S. Pat. Nos. 4,857,668; 5,054,635; 5,105,056; and 5,202,536.

Other low closure force gasket constructions which are particularly suited for flat panel applications such as I/O panels, backplanes, connectors, access panels, and the like are marketed by the Chomerics Division of Parker-Hannifin Corp., Woburn, Mass. under the tradename “Soft-Shield® 4800.” Such z-axis conductive constructions consist of foam core on one side of which is disposed a layer of a blend of conductive and non-conductive fibers and, optionally, a reinforcing fabric. Strands of the fibers on the one side of the gasket are interspersed through the thickness dimension of the foam core and heat set therein to provide the z-axis conductivity. Such constructions are further described in U.S. Pub. Nos. U.S. 2004/0209065 and 2004/0209064. Another foam-based EMI shielding gasket construction is shown in commonly-assigned U.S. Pat. No. 6,784,363.

Many electronic devices, including PC's and communication equipment, must not only comply with certain FCC requirements, but also must meet be approved under certain Underwriter's Laboratories (UL) standards for flame retardancy. In this regard, if each of the individual components within an electronic device is UL approved, then the device itself does not require separate approval. Ensuring UL approval for each component therefore reduces the cost of compliance for the manufacturer, and ultimately may result in cheaper goods for the consumer. For EMI shielding gaskets, however, such gaskets must be made flame retardant, i.e., achieving a rating of V-0 under UL Std. No. 94, “Tests for Flammability of Plastic Materials for Parts in Devices and Appliances” (1991), without compromising the electrical conductivity necessary for meeting EMI shielding requirements.

In this regard, and particularly with respect to EMI shielding gaskets of the above-described fabric over foam variety, it has long been recognized that foamed polymeric materials are flammable and, in certain circumstances, may present a fire hazard. Owing to their cellular structure, high organic content, and surface area, most foam materials are subject to relatively rapid decomposition upon exposure to fire or high temperatures.

One approach for imparting flame retardancy to fabric over foam gaskets has been to employ the sheathing as a flame resistant protective layer for the foam. Indeed, V-0rating compliance purportedly has been achieved by sheathing the foam within an electrically-conductive Ni/Cu-plated fabric to which a thermoplastic sheet is hot nipped or otherwise fusion bonding to the underside thereof. Such fabrics, which may be further described in one or more of U.S. Pat. Nos. 4,489,126; 4,531,994; 4,608,104; and/or 4,621,013, have been marketed by Monsanto Co., St. Louis, under the tradename “Flectrong® Ni/Cu Polyester Taffeta V0.”

Other fabric over foam gaskets, as is detailed in U.S. Pat. No. 4,857,668, incorporate a supplemental layer or coating applied to the interior surface of the sheath. Such coating may be a flame-retardant urethane formulation which also promotes the adhesion of the sheath to the foam. The coating additionally may function to reduce bleeding of the foam through the fabric which otherwise could compromise the electrical conductivity of the sheath.

Electrically-conductive, flame retardant materials for use in fabric-over-foam EMI shielding gaskets, and methods of manufacturing the same, also have been described in commonly-assigned U.S. Pat. Nos. 6,777,095; 6,716,536; 6,521,348; 6,387,523; and 6,248,393, and in commonly-assigned co-pending application U.S. Ser. No. 11/326,558, filed Jan. 5, 2006. Such materials, in having a layer of a flame retardant coating applied to one side of an electrically-conductive, generally porous fabric, afford UL94V-0 protection when used as a jacketing in a fabric-over-foam gasket construction.

Due to recent regulatory changes in Europe and elsewhere, electrical and electronic devices and equipment face increased restrictions as to flame retardancy. Accordingly, it is believed that further improvements in the design of flame retardant EMI shielding gaskets would be well-received by the electronics industry. Especially desired would be a flame retardant gasket constructions which achieve a UL94 rating of V-0 and also meets the stricter regulatory requirements such as European Union Directive 2002/95/EC, “Restriction on the Use of Certain Hazardous Substances (RoHS) in Electrical and Electronic Equipment.”

### BROAD STATEMENT OF THE INVENTION

The present invention is directed to foam-based EMI shielding gasket constructions and more particularly to such constructions which are z-axis and otherwise multi-planarly conductive as suited for use in flat panel and strip gasket applications such as I/O panels, backplanes, connectors, access panels, and the like. In impregnating the foam of the gasket with a water-borne or other solution of a flame retardant penetrate, the gaskets of the invention afford UL94 V-0 protection.

The foam may be so impregnated by its saturation with the solution of the flame retardant. Such saturation may be effected by immersing the foam in a bath of the flame retardant solution, and then alternately compressing and relaxing the foam so as to result in the absorption or other uptake of the solution into the foam. Upon its removal from the bath, the foam then may be compressed again to remove any excess solution, and then dried to evaporate the water or other solvent of the solution and thereby leaving a residue or other deposit of the flame retardant in the solution impregnated within the foam. The foam may be compressed and relaxed in a batchwise fashion such as through the use of a press or the like. Advantageously, however, the compression-relaxation cycling alternatively may be done in a continuous process with the foam being issued from a roll or the like and then pulled through a roller or series of rollers position both within and outside of the bath.

The present invention, accordingly, comprises the materials and/or methods possessing the construction, combination of elements, and/or arrangement of parts and steps which are exemplified in the detailed disclosure to follow. Advantages of the present invention include an economical, flame retardant EMI shielding gasket construction which may afford both RoHS compliance and UL94 V-0 protection. Additional advantages includes a flame retardant treatment method for such gaskets which allows the gasket to maintain electrical, mechanical, and physical properties comparable to untreated gaskets. These and other advantages will be readily apparent to those skilled in the art based upon the disclosure contained herein.

### BRIEF DESCRIPTION OF THE DRAWING

For a fuller understanding of the nature and objects of the invention, reference should be had to the following detailed description taken in connection with the accompanying drawing wherein:

FIG. 1 is a perspective end view of a section of a representative multi-planar EMI shielding gasket construction according to the present invention; and

FIG. 2 is a schematic of an illustrative process for imparting flame retrardency to the gasket construction of FIG. 1.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element. Terminology of similar import other than the words specifically mentioned above likewise is to be considered as being used for purposes of convenience rather than in any limiting sense. Further, the term “EMI shielding” should be understood to include, and to be used interchangeably with, electromagnetic compatibility (EMC), electrical conduction and/or grounding, corona shielding, radio frequency interference (RFI) shielding, and anti-static, i.e., electro-static discharge (ESD) protection. The terms “flame retardant” and “fire retardant” also may be used interchangeably.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

For the illustrative purposes of the discourse to follow, the flame retardant electromagnetic interference (EMI) shielding gasket construction herein involved is described in connection with its configuration as being z-axis and otherwise multi-planarly conductive as suited for use in applications such as I/O panels, back or face planes, connectors, access panels, circuit boards, card cages, vents, covers, PCMCIA cards, and shielding caps or cans for electronic devices, or for an enclosure or cabinet of such a device or other equipment. Further, the term “EMI shielding” should be understood to and the like. In such applications, the gasket may function between the mating surfaces to seal any interface gaps or other irregularities. That is, while under an applied pressure, the gasket resiliently conforms to any such irregularities both to establish a continuous conductive path across the interface, and may also finction to provide an environmental seal against the ingress of dust, moisture, or other contaminates.

In view of the discourse to follow, however, it will be appreciated that aspects of the present invention may find utility in other applications requiring a resilient, electrically conductive seal, gasket, fencing, or other connection, screen, or shield for EMI shielding or other purposes. Use within those such other applications therefore should be considered to be expressly within the scope of the present invention.

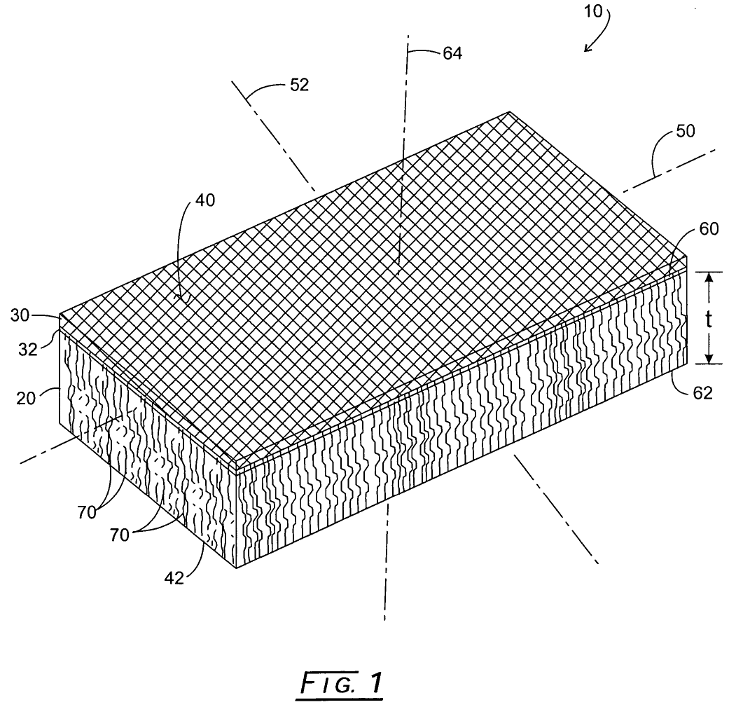

Referring then to the figures wherein corresponding reference characters are used to designate corresponding elements throughout the several views with equivalent elements being referenced with prime or sequential alphanumeric designations, a section of a flame retardant EMI shielding gasket construction according to the present invention is shown generally at 10 in FIG. 1. As supplied for use, gasket 10 may be provided on a roll or the like and then cut to size.

In basic construction, gasket 10, which is further described in U.S. Pub. Nos. US 2004/0209065 and 2004/0209064, includes a resilient core, 20, on one side of which is disposed a web or other fibrous layer, 30, and, optionally, a reinforcement layer, 32. Although shown for illustrative purposes to be a generally planar sheet, pad, or strip of indefinite extents, gasket 10 be of any given extents and shape.

Gasket 10 has a first surface, 40, and a second surface, 42, opposite the first surface 40. Surfaces 40 and 42, again for illustrative purposes, are shown to be generally planar, but alternatively may be multi-planar, arcuate or curved, or complex curved. In whatever geometry provided, each of the surfaces 40 and 42 extends along an x-axis, 50, and a y-axis, 52, disposed generally normal to the x-axis, 50.

Core 20 itself has a first side, 60, on which is disposed the web 30, and a opposite second side, 62, which forms the second surface 42 of the gasket. The first and second sides 60 and 62 of the core 20 defines a thickness dimension, referenced at “tₗ,” of the core therebetween which dimension extends along a z-axis, 64, disposed generally normal to the x-axis and a y-axes 50 and 52. For many applications, the core thickness tₗ, may be between about 0.5-10 mm, and typically, but not necessarily, will be small relative to the extents of the lengthwise or widthwise dimensions of the gasket 10 as defined along, respectively, the x and y-axes 50 and 52. When configured as a strip-type gasket, the lengthwise extent of the gasket 20 along the x-axis 50 will be large relative to the widthwise extent along the y-axis 52.

Core 20 is formed of a polymeric material which specifically may be selected as depending upon one or more of operating temperature, compression set, force defection, flammability, compression set, or other chemical or physical properties. Depending, then, upon the application, suitable materials may include, natural rubbers such as Hevea, as well as thermoplastic, i.e., melt-processible, or thermosetting, i.e., vulcanizable, synthetic rubbers such as fluoropolymers, chlorosulfonates, polybutadienes, buna-N, butyls, neoprenes, nitriles, polyisoprenes, silicones, fluorosilicones, copolymer rubbers such as ethylene-propylene (EPR), ethylene-propylene-diene monomer (EPDM), nitrile-butadienes (NBR) and styrene-butadienes (SBR), or blends such as ethylene or propylene-EPDM, EPR, or NBR. The term “synthetic rubbers” also should be understood to encompass materials which alternatively may be classified broadly as thermoplastic or thermosetting elastomers such as polynrethanes, styrene-isoprene-styrene (SIS), and styrene-butadiene-styrene (SBS), as well as other polymers which exhibit rubber-like properties such as plasticized nylons, polyesters, ethylene vinyl acetates, polyolefins, and polyvinyl chlorides. As used herein, the term “elastomeric” is ascribed its conventional meaning of exhibiting rubber-like properties of compliancy, resiliency or compression deflection, low compression set, flexibility, and an ability to recover after deformation.

For affording gap-filling capabilities in low closure force applications, i.e. between about 1-8 lb/inch (0.175-1.5 N/mm), the polymeric material forming core 20 is further is provided as a foam which may be an open cell foam. In the EMI shielding applications herein involved, foams generally are observed to complaint over a wide range of temperatures, and to exhibit good compression-relaxation hysteresis even after repeated cyclings or long compressive. Core 20 therefore particularly may be formed of a foamed elastomeric thermoplastic or “sponge” such as a foamed polyethylene, polypropylene, polyurethane, polyolefin resin/monoolefin copolymer blend (EPDM), butadiene, styrene-butadiene, nitrile, chlorosulfonate, neoprene, urethane, or silicone, or a foamed copolymer or blend thereof.

For improved tear resistance and strength, core 20 may be supported by or otherwise incorporate the reinforcement layer 34 such as interposed between the core first side 60 and the web 30. In the arrangement shown in FIG. 1, core 30 may be cast or otherwise formed directly on a sheet or other layer of the reinforcement member 34 to effect the bonding, via mechanical, chemical, electrostatic, adhesive, attractive, and/or other forces. Of course, the reinforcement member 34 alternatively, or additionally as a second sheet, may be bonded to or otherwise made integral with the core first side 60, or otherwise may be incorporated into the core 20 as one or more interlayers.

In the embodiment 10 of FIG. 1, the reinforcement member 34 may be film or other layer of a thermoplastic material such as a polyimide, polyethylene terephthalate (PET), polyetheretherketone (PEEK), or the like. Alternatively, the reinforcement member 34 may be provided as a layer of a fiberglass, synthetic or natural fiber, or metal wire cloth, screen, mesh, web, or other fabric, or as a layer of an aluminum or other metal foil. As mentioned the reinforcement member 34 may be used to improve the physical strength of the core 20 and otherwise to facilitate the handling thereof and its die cutting into a variety of geometries.

Web 30, which may be oriented or random, may be formed of a blend of one or more conductive fibers to render the web electrically conductive, and one or more polyester, polyolefin, polyamide, or other thermoplastic polymer or co-polymer fibers which may be softenable or meltable to heat set the web. By “electrically-conductive,” it is meant that the web may be rendered conductive, i.e., to a surface resistivity of about 0.5Ω/sq. or less, by reason of its being constructed of electrically-conductive wire, monofilaments, yarns or other fibers or, alternatively, by reason of a treatment such as a plating or sputtering being applied to non-conductive fibers to provide an electrically-conductive layer thereon.

Preferred electrically-conductive fibers include Monel nickel-copper alloy, silver-plated copper, nickel-clad copper, Ferrex® tin-plated copper-clad steel, aluminum, tin-clad copper, phosphor bronze, carbon, graphite, and conductive polymers. Preferred non-conductive fibers include cotton, wool, silk, cellulose, polyester, polyamide, nylon, and polyimide monofilaments or yams which are rendered electrically conductive with a metal plating of copper, nickel, silver, nickel-plated-silver, aluminum, tin, or a combination or alloy thereof. As is known, the metal plating may applied to individual fiber strands or to the surfaces of the fabric after weaving, knitting, or other fabrication.

To provide z-axis conductivity, as laid-up on the core 20, the web 30 may be needled, such as in the manner described in U.S. Pub. Nos. US 2004/0209065 and 2004/0209064, to punch strands of the fibers, commonly referenced at 70, through the thickness dimension t of the core 20 and through to the second side 62 thereof to be exposed on the second surface 42 of the gasket 10. Thereafter, the gasket 10 may be heated to soften or melt the thermoplastic fibers and thereby to fuse the web 20 into a consolidated structure. So formed, the gasket 20 may be observed to exhibit multi-planar electrical conductivity, i.e., conductivity in the direction of the x, y, and z-axes 50, 52, and 64.

Gasket 10 may be made flame retardant by impregnating the foamed polymeric material of the core 20, either as incorporated into the gasket 10 or as pre-treated prior top the manufacture of the gasket 10, with a water-borne or other solution of a flame retardant “penetrate,” such as an aqueous, pyrolitic, non-bromine, phosphorous-based formulation marketed under the name “Flamex PFTM,” by National Fireproofing Co. (Coal City, Ill.), or other formulation. Such solutions, wherein the flame retardant composition is dissolved, emulsified, or otherwise dispersed in water or another solvent, may an effective amount of one or more conventional flame retardant additives such as aluminum hydrate or other metal hydrates, antimony compounds such as antimony triacetate and antimony oxide, trioxide, and pentoxide, or other antimony or metal acetates or oxides, phosphate esters, halogenated compounds such as hexabromocyclododecane, decachlorodiphenyl ether, bis(tribromophenoxy)ethane, bis(tribromophenyl) ether, octabromodiphenyl oxide, poly(dibromophenylene oxide), hexabromobenzene, ethylenebistetrabromophthalimide, perchloropentacyclodecane, and decabromodiphenyl ether, decabromodiphenyl oxide, or other polybrominated diphenyl compound, and combinations thereof. Antimony-based flame retardant additives are further described in U.S. Pat. Nos. 4,727,107 and 4,710,317. Halogenated flame retardant compounds are further described in U.S. Pat. Nos. 4,727,107; 4,710,317; and 3,882,481.

The foamed polymeric material may be impregnated with the flame retardant composition by its saturation with the solution thereof. Such saturation may be effected by immersing the foam in a bath of the flame retardant solution, and then alternately compressing and relaxing the foam so as to result in the absorption or other uptake of the solution into the foam. Upon its removal from the bath, the foam then may be compressed again to remove any excess solution, and then dried to evaporate the water or other solvent of the solution and thereby leaving a residue or other deposit of the flame retardant in the solution impregnated within the foam. The foam may be compressed and relaxed in a batchwise fashion such as through the use of a press or the like. Advantageously, however, the compression-relaxation cycling alternatively may be done in an in-line continuous process with the foam being issued from a roll or the like and then pulled through a roller or series of rollers position both within and outside of the bath.

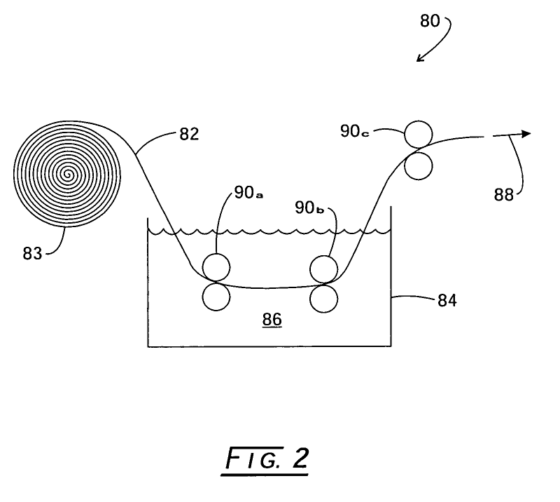

A schematic of such an in-line process is shown generally at 80 in FIG. 2. In such process 80, the foamed polymeric material, 82, as formed into the gasket 10 or prior thereto, may be supplied on a roll, 83. With a solution, 84, of the flame retardant composition, 84, being contained in a bath, 86, or the like, the material 82 may be pulled in the direction indicated by the arrow 88 through the bath 84 via a series of rollers, 90a-c, which may be arranged in pairs to pinch the material 82 therebetween. Within the bath 84, as pinched between the roller pairs 90a and 90b, the material 82 is alternately compressed any relaxed through two, or with additional roller pairs (not shown) more cycles, resulting the absorption or other uptake of the solution 86 unto the material 82. Upon being pulled from the bath 84, the now saturated or supersaturated material 82 once again may be pinched as passing between the roller pair 90c to thereby compress the material for the removal of any excess solution 86. Upon being dried to evaporated the water or other solvent, the material 82 is thereby impregnated with the flame retardant compounds of other composition of the solution, and then may be passed to in-line or off-line to a cutter, in the case of the material 82 being already formed into the gasket 10, or to a second line for forming the gasket 10 in the case of the material 82 being pretreated prior to the manufacture of it into the gasket 10.

Gasket construction 10 advantageously provides a structure that may be made flame retardant in the manner described without compromising its suitability for use in low closure force, i.e., between about 1-8 lb/inch (0.175-1.5 N/mm), applications. The result is a multi-planar EMI construction which, depending upon the selection of the flame retardant, may be made RoHS compliant and to exhibit a flame class rating of V-0 under UL94.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A method of imparting flame retardancy to an electromagnetic interference (EMI) shielding gasket construction, the gasket comprising a resilient layer formed of a foamed polymeric material, the method comprising the steps of:
(a) immersing the foamed polymeric material which forms the resilient layer of the gasket in a solution of a flame retardant composition dispersed in a solvent;
(b) compressing the material while immersed in the solution; and
(c) relaxing the material while immersed in the solution to uptake the solution into the material.

2. The method of claim 1 further comprising the additional steps after step (c) of:
(d) removing the material from the solution; and
(e) compressing the material to remove any excess solution from the material.

3. The method of claim 1 further comprising the additional steps after step (c) of:
(d) removing the material from the solution; and
(e) drying the material to evaporate the solvent and thereby impregnate the material with the flame retardant composition.

4. The method of claim 1 further comprising the additional steps after step (c) of:
(d) removing the material from the solution;
(e) compressing the material to remove any excess solution from the material; and
(f) drying the material to evaporate the solvent and thereby impregnate the material with the flame retardant composition.

5. The method of claim 1 wherein the gasket having a layer formed of the foamed polymeric material so treated by the method of steps (a)-(c) exhibits a flame class rating of V-0 under Underwriter's Laboratories (UL) Standard No. 94.

6. The method of claim 1 wherein:
the material has a first side and a second side which define a thickness dimension of the material therebetween; and
the material is compressed in step (b) through the thickness dimension thereof.

7. The method of claim 6 wherein:
the gasket further comprises a web formed on one of the sides of the material forming the resilient layer of the gasket, the web comprising fibers which are electrically-conductive, strands of the electrically-conductive fibers extending through the thickness dimension of the material from the one side of the material to the other to the other side thereof.

8. The method of claim 6 wherein the electrically-conductive fibers are non-conductive fibers having an electrically-conductive coating, metal wires, carbon fibers, graphite fibers, inherently-conductive polymer fibers, or a combination thereof.

9. The method of claim 8 wherein:
the non-conductive fibers are cotton, wool, silk, cellulose, polyester, polyamide, nylon, polyimide, or a combination thereof, and the electrically-conductive coating is copper, nickel, silver, aluminum, tin, carbon, graphite, or an alloy or combination thereof, and
the metal wires are copper, nickel, silver, aluminum, bronze, steel, tin, or an alloy or combination thereof, or one or more of copper, nickel, silver, aluminum, bronze, steel, tin, or an alloy or combination thereof coated with one or more of copper, nickel, silver, aluminum, bronze, steel, tin, or an alloy or combination thereof.

10. The method of claim 1 wherein the foamed polymeric material is selected from the group consisting of polyethylenes, polypropylenes, polypropylene-EPDM blends, butadienes, styrene-butadienes, nitrites, chlorosulfonates, neoprenes, urethanes, silicones, polyolefin resin/monoolefin copolymer blends, and copolymers, blends, and combinations thereof.

11. The method of claim 1 wherein the gasket having a layer formed of the foamed polymeric material so treated by the method of steps (a)-(c) complies with European Union Directive 2002/95/EC, “Restriction on the Use of Certain Hazardous Substances (RoHS) in Electrical and Electronic Equipment.”

12. The method of claim 1 wherein the flame retardant composition comprises one or more flame retard additives is selected from the group consisting of metal hydrates, acetates, or oxides, phosphate esters, halogenated compounds, and combinations thereof.

13. The method of claim 1 further comprises the addition step after step (c) of returning at least once to step (b) of the method,
method of imparting flame retardancy to an electromagnetic interference (EMI) shielding gasket construction, the gasket comprising a resilient layer formed of a foamed polymeric material, the method comprising the steps of:
(a) immersing the foamed polymeric material which forms the resilient layer of the gasket in a solution of a flame retardant composition dispersed in a solvent;
(b) compressing the material while immersed in the solution; and

14. The method of claim 1 wherein the solvent comprises water.

15. The method of claim 1 wherein the material is an open cell foam.
